(19) United States
(12) Patent Application Publication
(10) Pub. No.: US 2010/0151186 A1
(43) Pub. Date: Jun. 17, 2010

(54) COMPOSITE ARTICLE INCLUDING VISCOELASTIC LAYER WITH BARRIER LAYER

(75) Inventor: Larry S. Hebert, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/637,915

(22) Filed: Dec. 15, 2009

Related U.S. Application Data
(60) Provisional application No. 61/122,637, filed on Dec. 15, 2008.

(51) Int. Cl. B32B 3/12; B32B 5/18; B32B 27/04; B29C 39/20; B32B 27/36; B32B 27/00; B32B 27/38

(52) U.S. Cl. 428/116; 428/297.1; 264/257; 428/412; 428/421; 428/413

(57) ABSTRACT

Fiber reinforced resin matrix composite laminates are provided comprising first and second layers of fiber reinforced resin matrix comprising first and second resin matrices and a viscoelastic construction located between the first and second layers of fiber reinforced resin matrix, bound to the first and second resin matrices, comprising: i) at least one viscoelastic layer; and ii) at least one barrier layer. In some embodiments, the viscoelastic construction comprises at least two barrier layers which differ in composition from at least one viscoelastic layer and wherein the at least two barrier layers are bound to said first and second resin matrices. In some embodiments, the one or more barrier layer(s) may be substantially impermeable to organic solvents, and/or substantially impermeable to water, and/or substantially impermeable to gasses.

### CROSS REFERENCE TO RELATED APPLICATION

This application claims the benefit of U.S. Provisional Patent Application No. 61/122,637, filed Dec. 15, 2008, the disclosure of which is incorporated by reference herein in it entirety.

### FIELD OF THE DISCLOSURE

This disclosure relates to composite articles, such as fiber reinforced resin matrix or fiber reinforced plastic (FRP) matrix composite laminates, which include a viscoelastic construction located between and bound to layers of fiber reinforced resin matrix, which comprises at least one viscoelastic layer and at least one barrier layer.

### BACKGROUND OF THE DISCLOSURE

The use of fiber reinforced resin matrix or fiber reinforced plastic (FRP) matrix composite laminates (“composites”) has become widely accepted for the variety of applications in aerospace, automotive and other transportation industries because their light weight, high strength and stiffness. Weight reduction benefits and performance enhancements are the biggest drivers behind implementation of fiber reinforced resin matrix composite laminates into industrial applications. Various airspace components being manufactured from fiberglass and carbon fibers reinforced composites including airplane fuselage sections and wing structures. Composites are used to fabricate many parts for airplanes, wind generators, automobiles, sporting goods, furniture, buses, trucks, boats, train cars and other applications where stiff, light-weight materials, or consolidation of parts are beneficial. Most often the fibers are made of carbon, glass, ceramic or aramid, and the resin matrix is an organic thermosetting or thermoplastic material. These parts are typically manufactured under vacuum and/or pressure at temperatures from 20° C. to 180° C., occasionally up to 230° C., and occasionally up to 360° C.

### SUMMARY OF THE DISCLOSURE

Briefly, the present disclosure provides fiber reinforced resin matrix composite laminates comprising first and second layers of fiber reinforced resin matrix comprising first and second resin matrices and a viscoelastic construction located between the first and second layers of fiber reinforced resin matrix, bound to the first and second resin matrices, comprising: i) at least one viscoelastic layer; and ii) at least one barrier layer. In some embodiments, the viscoelastic and barrier layers may be one and the same layer. In some embodiments, the viscoelastic construction comprises a single layer which is both a viscoelastic layer and a barrier layer. In some embodiments, the viscoelastic construction is a single layer which is both a viscoelastic layer and a barrier layer. In some embodiments, at least one viscoelastic layer differs in composition from at least one barrier layer. In some embodiments, the viscoelastic and barrier layers may be one and the same layer or may be different layers. In some embodiments, the viscoelastic construction comprises at least two barrier layers which differ in composition from at least one viscoelastic layer and wherein the at least two barrier layers are bound to said first and second resin matrices. In some embodiments, the one or more barrier layer(s) may be substantially impermeable to organic solvents, and/or substantially impermeable to water, and/or substantially impermeable to gasses. In some embodiments, the viscoelastic layers may have a peak damping ratio (Tan δ) of at least 1.0 as measured in shear mode by DMTA at 10 Hz. In some embodiments, the viscoelastic construction additionally comprises at least one cured adhesive layer having a composition different from that of the resin matrix. In some embodiments, one or more layers of fiber reinforced resin matrix additionally comprise at least one core layer, which may optionally comprise foam, wood, or honeycomb construction.

In another aspect, the present disclosure provides a method of making a fiber reinforced resin matrix composite laminate comprising the steps of: providing first and second curable fiber reinforced resin matrixes comprising first and second curable resin matrixes; providing a viscoelastic construction comprising at least one viscoelastic layer and at least one barrier layer; providing a tool having a shape which is the inverse of the desired shape of the laminate; laying up the first curable fiber reinforced resin matrix, viscoelastic construction and the second curable fiber reinforced resin matrix in the tool, in that order; and curing the curable resin matrixes to make a fiber reinforced resin matrix composite laminate. In some embodiments, the viscoelastic and barrier layers may be one and the same layer. In some embodiments, the viscoelastic construction comprises a single layer which is both a viscoelastic layer and a barrier layer. In some embodiments, the viscoelastic construction is a single layer which is both a viscoelastic layer and a barrier layer. In some embodiments, at least one viscoelastic layer differs in composition from at least one barrier layer. In some embodiments, the viscoelastic and barrier layers may be one and the same layer or may be different layers. In some embodiments, the viscoelastic construction comprises at least two barrier layers which differ in composition from at least one viscoelastic layer and wherein the at least two barrier layers are bound to said first and second resin matrices. In some embodiments, the one or more barrier layer(s) may be substantially impermeable to organic solvents, and/or substantially impermeable to water, and/or substantially impermeable to gasses. In some embodiments, the viscoelastic layers may have a peak damping ratio (Tan δ) of at least 1.0 as measured in shear mode by DMTA at 10 Hz. In some embodiments, the viscoelastic construction additionally comprises at least one cured adhesive layer having a composition different from that of the resin matrix. In some embodiments, one or more layers of fiber reinforced resin matrix additionally comprise at least one core layer, which may optionally comprise foam, wood, or honeycomb construction.

In another aspect, the present disclosure provides a viscoelastic construction comprising at least one viscoelastic layer; bound to at least one barrier layer, where at least one barrier layer differs in composition from at least one viscoelastic layer. In some embodiments, the viscoelastic construction comprises at least two barrier layers bound to a viscoelastic layer, typically sandwiching the viscoelastic layer between barrier layers. In some embodiments, the one or more barrier layer(s) may be substantially impermeable to organic solvents, and/or substantially impermeable to water, and/or substantially impermeable to gasses. In some embodiments, the viscoelastic layers may have a peak damping ratio (Tan δ) of at least 1.0 as measured in shear mode by DMTA at 10 Hz.

### BRIEF DESCRIPTION OF THE DRAWING

FIG. 1 is schematic depiction of a comparative composite article as described in the Examples below.

FIG. 2 is schematic depiction of a composite article including a viscoelastic construction according to the present disclosure, as described in the Examples below.

FIG. 3 is schematic depiction of a composite article including a viscoelastic construction according to the present disclosure, as described in the Examples below.

FIG. 4 is schematic depiction of a composite article including a viscoelastic construction according to the present disclosure, as described in the Examples below.

FIG. 5 is schematic depiction of a composite article including a viscoelastic construction according to the present disclosure, as described in the Examples below.

FIG. 6 is schematic depiction of a composite article including a viscoelastic construction according to the present disclosure, as described in the Examples below.

### DETAILED DESCRIPTION

Fiber reinforced resin matrix or fiber reinforced plastic (FRP) matrix composite laminates (“composites”) has become widely accepted for the variety of applications in aerospace, automotive and other transportation industries because their light weight, high strength and stiffness. Viscoelastic layers may be included as intermediate layers of composite parts for purposes which may include vibration dampening and noise abatement.

The present disclosure provides, in some embodiments, a composite article including at least one intermediate viscoelastic construction which comprises at least one viscoelastic layer and at least one barrier layer located between the viscoelastic layer and the matrix of the composite. More typically the viscoelastic construction comprises at least two barrier layers, at least one between each face of the viscoelastic layer and the matrix of the composite. In some embodiments, additional viscoelastic layers and barrier layers are interleaved within the article.

In an alternate embodiment, the present disclosure provides a composite article comprising a viscoelastic construction including at least two intermediate viscoelastic layers having at least one barrier layer located between viscoelastic layers. In some embodiments, additional viscoelastic layers and barrier layers are interleaved within the article.

### Viscoelastic Layer

Any suitable viscoelastic material may be used in making the viscoelastic layer. Materials which may be useful may include those disclosed in U.S. Pat. Pub. No. 2008/0139722, the disclosure of which is incorporated herein by reference. Materials which may be useful may include 3M™ Ultra-Pure Viscoelastic Damping Polymer 242, 3M™ Viscoelastic Damping Polymer Type 830, 3M™ Viscoelastic Damping Polymer 110, VHB™ Adhesive Transfer Tapes 9469 and 300 MP available from 3M Company, St. Paul, Minn., USA. In some embodiments, viscoelastic layers which may be useful may have a peak damping ratio (Tan δ) of at least 0.20 as measured in shear mode by DMTA at 10 Hz. In some embodiments, viscoelastic layers which may be useful may have a peak damping ratio (Tan δ) of at least 0.30 as measured in shear mode by DMTA at 10 Hz. In some embodiments, viscoelastic layers which may be useful may have a peak damping ratio (Tan δ) of at least 0.40 as measured in shear mode by DMTA at 10 Hz. In some embodiments, viscoelastic layers which may be useful may have a peak damping ratio (Tan δ) of at least 0.60 as measured in shear mode by DMTA at 10 Hz. In some embodiments, viscoelastic layers which may be useful may have a peak damping ratio (Tan δ) of at least 0.80 as measured in shear mode by DMTA at 10 Hz. In some embodiments, viscoelastic layers which may be useful may have a peak damping ratio (Tan δ) of at least 1.0 as measured in shear mode by DMTA at 10 Hz.

### Barrier Layer

Any suitable barrier layer may be used. In some embodiments, the polymeric barrier layer may be selected from polyurethanes, polyureas, polyesters, polyimides, polybutadienes, elastomers, epoxies, fluoropolymers, polycarbonates, mixtures of the above. Typically the polymeric barrier layer is of a material that can be used to manufacture parts that are cured or formed under vacuum and/or pressure at temperatures from 20° C. to 180° C. without excessive flow or loss of integrity. In some embodiments the polymeric barrier layer is fully cured. In some embodiments the polymeric barrier layer is partially cured, typically at least 50% cured, more typically at least 60% cured, more typically at least 70% cured, more typically at least 80% cured, and more typically at least 90% cured. In some embodiments the polymeric barrier layer is thermoplastic. Each barrier layer typically has a thickness of less than 10 mil, more typically less than 6 mil, more typically less than 4 mil, more typically less than 3 mil, more typically less 2 mil, more typically less than 1 mil, in some embodiments less than 0.75 mil, in some embodiments less than 0.60 mil, in some embodiments less than 0.50 mil, in some embodiments less than 0.25 mil, in some embodiments less than 0.10 mil, in some embodiments less than 0.05 mil, and in some embodiments less than 0.01 mil. Each barrier layer typically has a thickness of at least 0.001 mil. Typically the barrier layer is substantially impermeable to gasses. More typically the barrier layer remains substantially impermeable to gasses throughout the process of manufacturing a composite of which it is a part. In some embodiments, substantially impermeable to gasses means having an oxygen permeability of less than 35 cm³-mm/m²/day/atm. Typically the barrier layer is substantially impermeable to moisture. More typically the barrier layer remains substantially impermeable to moisture throughout the process of manufacturing a composite of which it is a part. In some embodiments, substantially impermeable to moisture means having a moisture vapor transmission rate of less than 30 gm/m²/day. Typically the barrier layer is substantially impermeable to organic solvents. More typically the barrier layer remains substantially impermeable to organic solvents throughout the process of manufacturing a composite of which it is a part. In some embodiments, such organic solvents may include fuels, aircraft fuels, lubricants, hydraulic fluids, and the like. In some embodiments, substantially impermeable to an organic solvent means exhibiting less than 10% weight gain or loss after 7 days exposure to the solvent at 21° C. and 1 atmosphere. In some embodiments, substantially impermeable to organic solvents means exhibiting less than 10% weight gain or loss after 7 days exposure to methylene chloride at 21° C. and 1 atmosphere. In some embodiments, substantially impermeable to organic solvents means exhibiting less than 10% weight gain or loss after 7 days exposure to benzyl alcohol at 21° C. and 1 atmosphere. In some embodiments, substantially impermeable to organic solvents means exhibiting less than 10% weight gain or loss after 7 days exposure to gasoline at 21° C. and 1 atmosphere. In some embodiments, the barrier layer is electrically non-conductive. More typically the barrier layer remains electrically non-conductive throughout the process of manufacturing a composite of which it is a part. The barrier layer optionally includes flame retardant ingredients or additives.

In some embodiments, barrier layers may comprise materials such as polyethylene, polyurethane, polycarbonate and polyimide films including Kapton™ available from DuPont Films, Buffalo, N.Y. The barrier layers may be clear and colorless, or include a colorant, such as a pigment or dye as the application requires. The barrier layer may be alloys of these materials and optionally include flame retardant ingredients or other additives, such as a polyurethane/polycarbonate blend resin with UV absorbers available as U933 from Alberdingk Boley GmbH., Krefeld, Germany.

In some embodiments, barrier layers may comprise materials such as fluorinated polymers. In some embodiments, barrier layers may comprise perfluorinated fluoropolymers. In some embodiments, barrier layers may comprise non-perfluorinated fluoropolymers, such as polymer which may include interpolymerized units derived from vinylidene fluoride (VDF). Such materials typically include at least about 3 weight percent of interpolymerized units derived from VDF, which may be homopolymers or copolymers with other ethylenically unsaturated monomers, such as hexafluoropropylene (HFP), tetrafluoroethylene (TFE), chlorotrifluoroethylene (CTFE), 2-chloropentafluoropropene, perfluoroalkyl vinylethers, perfluorodiallylether, perfluoro-1,3-butadiene, and/or other perhalogenated monomers and further derived from one or more hydrogen-containing and/or non-fluorinated olefinically unsaturated monomers. Such fluorine-containing monomers may also be copolymerized with fluorine-free terminally unsaturated olefinic comonomers, such as ethylene or propylene. Useful olefinically unsaturated monomers may include alkylene monomers such as 1-hydropentafluoropropene, 2-hydropentafluoropropene, etc. Such fluoropolymers may include tetrafluoroethylene-hexafluoropropylene-vinylidene fluoride terpolymers and hexafluoropropylene-vinylidene fluoride copolymers. Commercially available fluoropolymer materials which may be useful may include, for example, THV 200, THV 400, and THV 500 fluoropolymers, which are available from Dyneon LLC of Oakdale, Minn., and SOLEF 11010 and SOLEF 11008, which are available from Solvay Polymers Inc., Houston, Tex., KYNAR® and KYNAR FLEX® PVDF which are available from Arkema Inc., Philadelphia, Pa., and TEFZEL LZ300 fluoropolymers, which are available from DuPont Films, Buffalo, N.Y. Additional commercially available fluoroelastomer materials of this type include, for example, FC-2145, FC-2178, FC-2210X, FC-2211, FC-2230 which are available from Dyneon LLC of Oakdale, Minn., and Technoflon® fluoroelastomers which are available from Solvay Polymers Inc., Houston, Tex. Other useful fluorinated polymers, may include non-perfluorinated polymers, which may include poly(vinylfluoride), such as TEDLAR TAW15AHS, which is available from DuPont Films of Buffalo, N.Y. Blends of fluoropolymers can also be used to make the barrier layers of the present disclosure. Commercially available fluoropolymer materials of this type include, for example, polyvinylidene fluoride alloy films available as DX Film from Denki Kagaku Kogyo Kabushiki Kaisha, Tokyo, JAPAN. Blends of two different types of non-perfluorinated fluoropolymers may be useful, as well as blends of a non-perfluorinated fluoropolymer with a perfluorinated fluoropolymer. Furthermore, blends of fluoropolymers with nonfluoropolymers, such as polyurethane and polyethylene, for example, can also be used.

Barrier layers for use in the present disclosure can be made by any suitable method, which may include cast and extrusion methods.

In some embodiments, barrier layers may be clear and colorless, or may include a colorant, such as a pigment or dye as the application desires. Typically, the colorant is an inorganic pigment, such as those disclosed in U.S. Pat. No. 5,132,164. In some embodiments, the pigment may be incorporated into one or more nonfluorinated polymers, which can be blended with one or more fluorinated polymers. In some embodiments, the barrier layers may be finish and/or color-matched to existing appliqué or paint color schemes.

Optionally, at least one of the surfaces may be treated to allow for bonding of adjacent layers. Such treatment methods include corona treatment, particularly corona discharge in an atmosphere containing nitrogen, and about 0.1 to about 10 volume percent of an additive gas selected from the group consisting of hydrogen, ammonia, and mixtures thereof, as disclosed in U.S. Pat. No. 5,972,176 (Kirk et al.). Another useful treatment method includes a chemical etch using sodium naphthalenide. Such treatment methods are disclosed in Polymer Interface and Adhesion, Souheng Wu, Ed., Marcel Dekker, Inc., NY and Basel, pp. 279-336 (1982), and Encyclopedia of Polymer Science and Engineering, Second Edition, Supplemental Volume, John Wiley & Sons, pp. 674-689 (1989). Another useful treatment method is the FLUOROETCH process, available from Acton Industries, Inc., Pittston, Pa. Other useful treatments for surface modification of fluoropolymers include methods that expose a light absorbing electron donor to actinic radiation in the presence of a fluoropolymer such as those disclosed in U.S. Pat. No. 6,630,047 (Jing et al.) and U.S. Pat. No. 6,685,793 (Jing). Other treatment methods include the use of such materials as primers. These may be employed either in place of, or in addition to the surface treatments described above. An example of a useful primer is ADHESION PROMOTER #86A (a liquid primer, available from Minnesota Mining and Manufacturing Company, St. Paul, Minn.).

### Viscoelastic Construction

A viscoelastic construction according to the present disclosure may be made by any suitable method. Typically, one or more viscoelastic layers and one or more barrier layers are joined by any suitable method, including lamination, adhesive bonding by addition of an adhesive layer, adhesive bonding by the adhesive properties of the barrier or viscoelastic layer(s) themselves, or the like. Typically, the layers of the viscoelastic construction are joined prior to use in manufacture of a composite article, however, in some embodiments the layers become joined during manufacture of a composite article. In some embodiments, a single material may perform as both barrier layer and viscoelastic layer. Some such embodiments may comprise a single layer of material. In some embodiments, barrier layer(s) and viscoelastic layer(s) are different materials.

In one embodiment, the present disclosure provides a viscoelastic construction (layered article) comprising at least one viscoelastic layer laminated with at least one barrier layer, more typically at least one viscoelastic layer laminated between at least two barrier layers, and methods of using the article in the manufacture of composite parts, and composite parts made with such a laminated article. In some embodiments, the layered article may comprise a single polymeric barrier layer and a single viscoelastic layer. In some embodiments, the layered article may comprise a single viscoelastic layer sandwiched between two barrier layers. In some embodiments, the layered article may comprise more than one polymeric barrier layer. In some embodiments, the layered article may comprise more than one viscoelastic layer.

In some embodiments, the layered article does not comprise filler materials. In some embodiments, the layered article does not comprise inorganic filler materials. In some embodiments, the layered article does not comprise organic filler materials. In some embodiments, the layered article does not comprise fibrous filler materials. In some embodiments, the layered article does not comprise non-fibrous filler materials. In some embodiments, the layered article does not comprise particulate filler materials. In some embodiments, the layered article does not comprise any fibrous scrim, such as a woven scrim or a non-woven scrim.

### Composite Article

A composite article according to the present disclosure may be made by any suitable method. Typically, curable fiber reinforced resin matrix prepregs are used, however, in other embodiments resin matrix and fiber reinforcement may be combined in manufacture of the composite article. Any suitable fiber or matrix materials may be used, many of which are known in the art. Typically, a mold or form designated a tool is used, the tool having a shape which is the inverse of the desired shape of the laminate. Typically one or more curable fiber reinforced resin matrixes are laid up in the tool, followed by the viscoelastic construction or components thereof, followed by one or more additional (second) curable fiber reinforced resin matrixes. Thereafter the lay-up is cured by methods known in the art.

In some embodiments, the composite article additionally comprises at least one core layer. In some embodiments, the core layer may comprise foam, wood, or honeycomb construction. Such core layers may be laid up between curable fiber reinforced resin matrix layers in the manufacture of a composite article. In some embodiments, the layered article comprises no such a core layer.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

### Methods

General Tooling and Bagging of a Composite Part

A composite specimen with a curable epoxy adhesive resin was prepared for curing in the following manner. A flat tool was fabricated by trimming to 2 ft×2 ft a 12 gauge stainless steel alloy 304 with 2B finish. A 1 mil PTFE non-perforated parting film (available as HTF-621 from Northern Fiber Glass Sales, Inc.) was applied to the tool and affixed thereon with heat resistant tape applied at the edges and corners of the film. Each layer of material was applied to the tool in the order and arrangement described in the example text. Each layer was applied first to the tool, then one upon the other without liners by hand and each layer was consolidated with the previous layer(s) by passing a 1.5 inch diameter wooden roller over the upper-most layer while applying hand pressure to the roller. After every forth ply, the part and tool were covered with a layer of perforated parting film described below and then a layer of breather ply described below and the part was compacted to the tool under full vacuum in a Scotchlite™ Vacuum Applicator Model VAL-1 manufactured by 3M for 3 minutes after which time the breather ply and perforated parting film were removed and additional plies were added to the part. Each coupon was permanent marked by applying a unique identifier along one edge of the part on the exposed face of the part using a Pilot Silver Marker. A perforated parting film available as A5000 from Richmond Aircraft Products was applied wrinkle-free so as to completely cover the exposed face of the coupon. 1 thermocouple was attached to the tool within 2 inches of the coupon. A layer of non-perforated parting film was applied to the bed of the autoclave described below to cover the area where the tools were placed. The tool and part were placed on the bed of the autoclave described below and a continuous bead of vacuum bag sealing tape was applied directly to the bed of the autoclave so that the distance from the tape to the tool was at least 3 inches. The exposed non-perforated parting film on the bed of the autoclave was folded or trimmed clear of the vacuum bag sealing tape. A non-woven polyester 10 oz/yd² felt breather ply (available as RC-3000-10 from Richmond Aircraft Products) was overlaid upon the part and the tool and onto the bed of the autoclave such that it extended to within 2 inches of the vacuum bag sealing tape on all sides. A 3 mil high temperature nylon bagging film (available as HS8171 from Richmond Aircraft Products) was placed loosely over the bed of the autoclave to cover the part and tools and to extend to or beyond the vacuum bag sealing tape on all sides. At least 1 vacuum port assembly was installed in the vacuum bag over the breather ply and the vacuum bag was sealed to the bed of the autoclave along all edges by pressing the film against the vacuum bag seal tape.

### High Pressure Curing of a Composite Part

A composite specimen with a curable epoxy adhesive resin was cured in the following manner. Each composite specimen with a curable epoxy adhesive resin was prepared for curing according to “General Tooling and Bagging of a Composite Part”. The vacuum port assembly(ies) was attached to the vacuum system in the autoclave described below and the parts, tools, parting films and breather plies were consolidated under full vacuum for 5 minutes. The thermocouples were attached to the control system in the autoclave. The part was then cured under controlled temperature and pressure conditions in one of two autoclaves, one made by Thermal Equipment Corporation or the other made by ASC Process Systems, using pressure and temperature profiles described below. The pressure inside the autoclave was increased to 60 psi and the vacuum to the vacuum port assemblies was removed when the pressure in the autoclave reached 15 psi and the temperature was increased at 5° F./minute until the temperature of the lagging thermocouple reached 177° C. The pressure was maintained between 60 psi and 70 psi and the temperature was maintained between 177° C. and 182° C. for 120 minutes. The temperature was reduced at a controlled rate of 5° F./minute until the temperature of the lagging thermocouple reached 44° C. The pressure was maintained between 60 psi and 70 psi until the temperature of the lagging thermocouple reached 66° C., then the pressure in the autoclave was vented to the atmosphere. The cured composite specimen was removed from the autoclave, bagging and tool.

Low Pressure ½ Hour Curing of a Composite Part

A composite specimen with a curable epoxy adhesive resin was cured in the following manner. Each composite specimen with a curable epoxy adhesive resin was prepared for curing according to “General Tooling and Bagging of a Composite Part”. The vacuum port assembly(ies) was attached to the vacuum system in the autoclave described below and the parts, tools, parting films and breather plies were consolidated under full vacuum for 5 minutes. The thermocouples were attached to the control system in the autoclave. The part was then cured under controlled temperature and pressure conditions in one of two autoclaves, one made by Thermal Equipment Corporation or the other made by ASC Process Systems, using pressure and temperature profiles described below. The pressure inside the autoclave was increased to 45 psi and the vacuum to the vacuum port assemblies was removed when the pressure in the autoclave reached 15 psi and the temperature was increased at 5° F./minute until the temperature of the lagging thermocouple reached 177° C. The pressure was maintained between 40 psi and 50 psi and the temperature was maintained between 177° C. and 182° C. for 90 minutes. The temperature was reduced at a controlled rate of 5° F./minute until the temperature of the lagging thermocouple reached 44° C. The pressure was maintained between 40 psi and 50 psi until the temperature of the lagging thermocouple reached 66° C., then the pressure in the autoclave was vented to the atmosphere. The cured composite specimen was removed from the autoclave, bagging and tool.

### Low Pressure 2 Hour Curing of a Composite Part

A composite specimen with a curable epoxy adhesive resin was cured in the following manner. Each composite specimen with a curable epoxy adhesive resin was prepared for curing according to “General Tooling and Bagging of a Composite Part”. The vacuum port assembly(ies) was attached to the vacuum system in the autoclave described below and the parts, tools, parting films and breather plies were consolidated under full vacuum for 5 minutes. The thermocouples were attached to the control system in the autoclave. The part was then cured under controlled temperature and pressure conditions in one of two autoclaves, one made by Thermal Equipment Corporation or the other made by ASC Process Systems, using pressure and temperature profiles described below. The pressure inside the autoclave was increased to 45 psi and the vacuum to the vacuum port assemblies was removed when the pressure in the autoclave reached 15 psi and the temperature was increased at 5° F./minute until the temperature of the lagging thermocouple reached 177° C. The pressure was maintained between 40 psi and 50 psi and the temperature was maintained between 177° C. and 182° C. for 120 minutes. The temperature was reduced at a controlled rate of 5° F./minute until the temperature of the lagging thermocouple reached 44° C. The pressure was maintained between 40 psi and 50 psi until the temperature of the lagging thermocouple reached 66° C., then the pressure in the autoclave was vented to the atmosphere. The cured composite specimen was removed from the autoclave, bagging and tool.

### General Laminating

Layers in the construction were brought together in combinations, order and quantities as described below. Removable carriers were separated from mating surfaces during the laminating process. These layers were laminated by feeding them at a rate of 2.5 ft/min into the nip of a Geppert Engineering Inc. laminator using 4 inch rubber rollers a ambient conditions (22° C.; 50 percent Relative Humidity).

### Intermediate Assembly Examples:

### Polyurethane/Polycarbonate Barrier Layer, 200

A polyurethane/polycarbonate barrier layer was provided in the following manner. A polymer solution was prepared. More specifically, 100 parts of transparent polyurethane/polycarbonate resin with 3% UV Absorber available as U933 from Alberdingk, and 1.5 parts polyfunctional aziridine crosslinker available as Neocryl CX-100 from Neoresins Inc. were added to a one liter, narrow-mouthed bottle. The solution was mixed by stirring with a wooden tongue depressor for 3 minutes at ambient conditions (22° C.; 50 percent Relative Humidity). The final polymer solution was then poured onto the surface of an untreated 2 mil transparent polyester film, and coated using a knife-over-bed coating station. The gap between knife and bed was set to be 1.5 mils greater than the thickness of the polyester carrier web. The coated backing was dried at 55° C. for 1 hour in a 9 ft³ vented recirculating oven manufactured by the Dispatch Oven Company. After drying, the thickness of the polyurethane/polycarbonate film was approximately 0.5 mil. A transparent UV absorbing polyurethane/polycarbonate film was obtained.

### Fluoroelastomer Barrier Layer, 210

A fluoroelastomer barrier layer was provided in the following manner. A polymer solution was prepared. More specifically, 1 part of Dyneon™ Fluoroelastomer FC2178 transparent fluoroelastomer resin available from Dyneon™ was dissolved in 4 parts, by weight, MEK in a one liter, narrow-mouthed bottle. The final polymer solution was then poured onto the surface of a silicone treated 4 mil paper liner, and coated using a knife-over-bed coating station. The gap between knife and bed was set to yield a 1 mil dry film. The coated backing was dried at 55° C. for 1 hour in a 9 ft³ vented recirculating oven manufactured by the Dispatch Oven Company. A transparent, UV stable, fluid resistant fluoroelastomer film was obtained.

Viscoelastic Construction with a Barrier Layer Each Side of Viscoelastic Material (VEM) Layer, 10

With reference to the FIG. 2, a viscoelastic material 300 and a polyurethane/polycarbonate barrier layer 200 were provided and used to prepare a modified viscoelastic construction 10. More specifically, the following materials were assembled and laminated as described in “General Laminating” above. First, a ½ mil thick barrier layer 200 per “Polyurethane/Polycarbonate Barrier Layer” above was joined to one side of a 2 mil thick viscoelastic damping polymer 300, available as 3M™ Viscoelastic Damping Polymers Type 830 from 3M Company, which has a peak damping ratio (Tan δ) of greater than 1.0 as measured in shear mode by DMTA at 10 Hz. To the other side of the 2 mils viscoelastic damping polymer 300 was joined another ½ mil thick barrier layer 200 per “Polyurethane/Polycarbonate Barrier Layer” above. All remaining liners and carriers were removed, providing a 3 mil thick modified viscoelastic construction 10. The character of the viscous-elastic material 300 was to be easily torn by hand, unable to support itself in a free-standing state, and very tacky at ambient conditions (22° C.; 50 percent Relative Humidity). The character of the modified viscoelastic construction 10 was to be very elastic, film-like in the free standing state, and lacking tack at ambient conditions (22° C.; 50 percent Relative Humidity). A non-tacky, stiffened, viscoelastic construction was obtained.

Viscoelastic Construction with a Fluoroelastomer Barrier Layer Each Side of VEM Layer, 12

With reference to FIG. 5 a viscoelastic material 300 and a fluoroelastomer barrier layer 210 were provided and used to prepare a modified viscoelastic construction 12. More specifically, the following materials were assembled and laminated as described in “General Laminating” above. First, a 1 mil thick barrier layer 210 per “Fluoroelastomer Barrier Layer” above was joined to one side of a 2 mils viscoelastic damping polymer 300 available as 3M™ Viscoelastic Damping Polymers Type 830 from 3M. To the other side of the 2 mils viscous-elastic damping polymer 300 was joined another 1 mil thick barrier layer 210 per “Fluoroelastomer Barrier Layer” above. All remaining liners and carriers were removed, providing a 4 mil thick modified viscoelastic construction 12. The character of the viscous-elastic material 300 was to be easily torn by hand, unable to support itself in a free-standing state, and very tacky at ambient conditions (22° C.; 50 percent Relative Humidity). The character of the modified viscoelastic construction 12 was to be very elastic, film-like in the free standing state, and lacking tack at ambient conditions (22° C.; 50 percent Relative Humidity). A non-tacky, stiffened, viscoelastic construction was obtained.

Viscoelastic Construction with a Fluoropolymer Barrier Layer Each Side of VEM Layer, 13

With reference to FIG. 6, a viscous-elastic material 300 and a fluoropolymer barrier layer 211 were provided and used to prepare a modified viscoelastic construction 13. More specifically, the following materials were assembled and laminated as described in “General Laminating” above. First, a 30 micron thick barrier layer polyvinylidene fluoride alloy film available as DX Film from Denka 211 was joined to one side of a 2 mils viscous-elastic damping polymer 300 available as 3M™ Viscoelastic Damping Polymers Type 830 from 3M 300. To the other side of the 2 mils viscous-elastic damping polymer 300 was joined another 30 micron thick barrier layer polyvinylidene fluoride alloy film available as DX Film from Denka 211. All remaining liners and carriers were removed, providing a 4 mil thick modified viscoelastic construction 13. The character of the viscoelastic material 300 was to be easily torn by hand, unable to support itself in a free-standing state, and very tacky at ambient conditions (22° C.; 50 percent Relative Humidity). The character of the modified viscoelastic construction 13 was to be very elastic, film-like in the free standing state, and lacking tack at ambient conditions (22° C.; 50 percent Relative Humidity). A non-tacky, stiffened, viscoelastic construction was obtained.

Viscoelastic Construction with a Barrier Layer Each Side and Between Two VEM Layers, 11

With reference to FIG. 3, a viscoelastic material 300 and viscoelastic material 301 and a polyurethane/polycarbonate barrier layer 200 were provided and used to prepare a multi-layered modified viscoelastic construction 11, each viscoelastic material having properties suited to dampen different frequencies at different temperatures. More specifically, the following materials were assembled and laminated as described in “General Laminating” above. First, a ½ mil thick barrier layer 200 per “Polyurethane/Polycarbonate Barrier Layer” above was joined to one side of a 2 mil thick viscoelastic film of damping polymer 300 available as 3M™ Viscoelastic Damping Polymers Type 830 from 3M. To the other side of the 2 mils viscoelastic damping polymer film 300 was joined another ½ mil thick barrier layer 200 per “Polyurethane/Polycarbonate Barrier Layer” above. To this barrier layer 200 was joined a 2 mils thick viscoelastic acrylic damping film 301 available as 3M™ Adhesive Transfer Tape 300 MP from 3M Company. To the other side of the viscoelastic acrylic damping film 301 was joined another ½ mil thick barrier layer 200 per “Polyurethane/Polycarbonate Barrier Layer” above. All remaining liners and carriers were removed, providing a 5.5 mil thick multi-layered modified viscoelastic construction 11. The character of the viscoelastic materials 300 and 301 was to be easily torn by hand, unable to support itself in a free-standing state, and very tacky at ambient conditions (22° C.; 50 percent Relative Humidity). The character of the modified viscoelastic construction 11 was to be very elastic, film-like in the free standing state, and lacking tack at ambient conditions (22° C.; 50 percent Relative Humidity). A non-tacky, stiffened, multi-layered viscoelastic construction was obtained.

### Cured Examples:

### (Comparative) Fiber Reinforced Resin Matrix Composite Laminate 50 C—Carbon Fiber Reinforced Plastic (CFRP) Either Side of VEM Layer

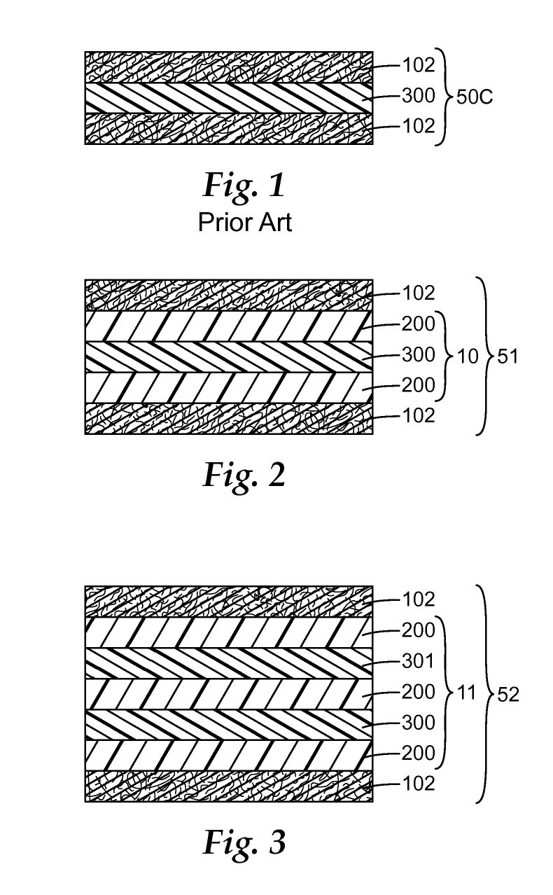

With reference to the FIG. 1, epoxy resin impregnated carbon fiber tape and a viscous-elastic material were provided and used to prepare comparative composite specimen 50 C. More specifically, the following materials were assembled and prepared as described in “General Tooling and Bagging of a Composite Part” above. Applied first to the tool were 4 plies epoxy resin impregnated unidirectional graphite fibers 102, available as P2353U 19 152 from Toray. Then applied was a 2 mil film of viscoelastic damping polymer 300, available as 3M™ Viscoelastic Damping Polymers Type 830 from 3M Company. Lastly applied was 4 plies epoxy resin impregnated unidirectional graphite fibers 102, available as P2353U 19 152 from Toray. The curable resins in this assembly were cured as described in “High Pressure Curing of a Composite Part” above.

### Fiber Reinforced Resin Matrix Composite Laminate 51—CFRP and Barrier Layer Either Side of VEM Layer

With reference to FIG. 2, epoxy resin impregnated carbon fiber tape and a modified viscoelastic construction were provided and used to prepare a composite specimen 51. More specifically, the following materials were assembled and prepared as described in “General Tooling and Bagging of a Composite Part” above. Applied first to the tool were 4 plies epoxy resin impregnated unidirectional graphite fibers 102, available as P2353U 19 152 from Toray. Then applied was 3 mil thick modified viscoelastic construction 10, having barrier layers 200 either side of a viscoelastic material 300. Lastly applied was 4 plies epoxy resin impregnated unidirectional graphite fibers 102, available as P2353U 19 152 from Toray. The curable resins in this assembly were cured as described in “High Pressure Curing of a Composite Part” above.

### Fiber Reinforced Resin Matrix Composite Laminate 52—CFRP and Barrier Layer Either Side and Between 2 Layers of VEM

With reference to the FIG. 3, epoxy resin impregnated carbon fiber tape and a multi-layered modified viscoelastic construction were provided and used to prepare a composite specimen 52. More specifically, the following materials were assembled and prepared as described in “General Tooling and Bagging of a Composite Part” above. Applied first to the tool were 4 plies epoxy resin impregnated unidirectional graphite fibers 102, available as P2353U 19 152 from Toray. Then applied was 5.5 mil thick multi-layered modified viscoelastic construction 11, having barrier layers 200 on either side of and between 2 layers of viscous-elastic material 301, 300. Lastly applied was 4 plies epoxy resin impregnated unidirectional graphite fibers 102, available as P2353U 19 152 from Toray. The curable resins in this assembly were cured as described in “High Pressure Curing of a Composite Part” above.

### Fiber Reinforced Resin Matrix Composite Laminate 54—CRFP Either Side of Fluoroelastomer Barrier Layer

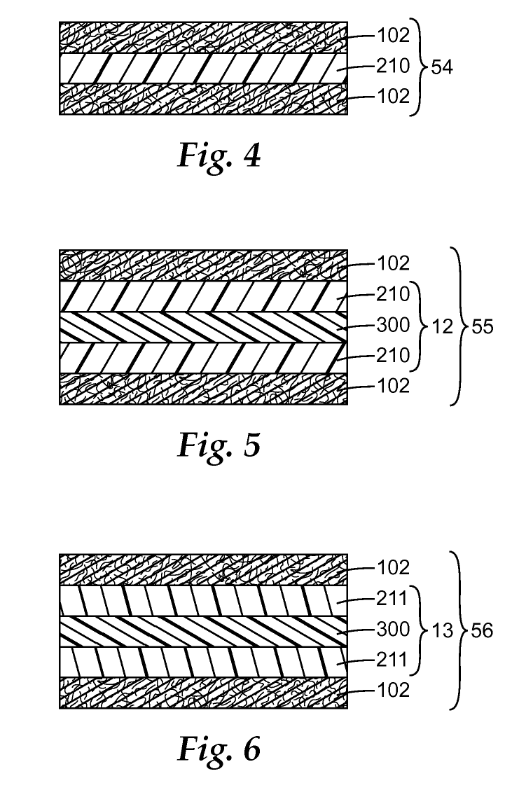

With reference to the FIG. 4, epoxy resin impregnated carbon fiber tape and a fluoroelastomer material were provided and used to prepare a composite specimen 54. More specifically, the following materials were assembled and prepared as described in “General Tooling and Bagging of a Composite Part” above. Applied first to the tool were 4 plies epoxy resin impregnated unidirectional graphite fibers 102, available as P2353U 19 152 from Toray. Then applied were 2 films of 1 mil thick fluoroelastomer barrier layer 210, per “Fluoroelastomer Barrier Layer” above, applied one upon the other for a total thickness of 2 mil. Lastly applied was 4 plies epoxy resin impregnated unidirectional graphite fibers 102, available as P2353U 19 152 from Toray. The curable resins in this assembly were cured as described in “High Pressure Curing of a Composite Part” above.

### Fiber Reinforced Resin Matrix Composite Laminate 55—CRFP and Fluoroelastomer Barrier Layer Either Side of VEM Layer

With reference to the FIG. 5, epoxy resin impregnated carbon fiber tape and a modified viscoelastic construction were provided and used to prepare a composite specimen 55. More specifically, the following materials were assembled and prepared as described in “General Tooling and Bagging of a Composite Part” above. Applied first to the tool were 4 plies epoxy resin impregnated unidirectional graphite fibers 102, available as P2353U 19 152 from Toray. Then applied was 4 mil thick modified viscoelastic construction 12 having fluoroelastic barrier layers 210, per “Fluoroelastomer Barrier Layer” above, on either side of a viscoelastic material 300. Lastly applied was 4 plies epoxy resin impregnated unidirectional graphite fibers 102, available as P2353U 19 152 from Toray. The curable resins in this assembly were cured as described in “High Pressure Curing of a Composite Part” above.

### Fiber Reinforced Resin Matrix Composite Laminate 56—CRFP and Fluoropolymer Barrier Layer Either Side of VEM Layer

With reference to the FIG. 6, epoxy resin impregnated carbon fiber tape and a modified viscoelastic construction were provided and used to prepare a composite specimen 56. More specifically, the following materials were assembled and prepared as described in “General Tooling and Bagging of a Composite Part” above. Applied first to the tool were 4 plies epoxy resin impregnated unidirectional graphite fibers 102 available as P2353U 19 152 from Toray. Then applied was a 4 mil thick modified viscoelastic construction 13 having fluoropolymer barrier layers 211 either side of a viscoelastic material 300. Lastly applied was 4 plies epoxy resin impregnated unidirectional graphite fibers 102 available as P2353U 19 152 from Toray. The curable resins in this assembly were cured as described in “High Pressure Curing of a Composite Part” above.

### Evaluations

After curing, coupons from fiber reinforced resin matrix composite laminates 50C, 51, 52, 54, 55, and 56 were trimmed with a diamond saw to 17.5 mm by 6.0 mm specimens. All samples included a vibration damping layer within the composite lay-up. Each specimen was tested in a multi-frequency strain single cantilever mode on a TA Instruments Dynamic Mechanical Thermal Analyzer (DMTA) at frequencies of 0.1, 1.0, 10 and 100 Hz sweeping the temperature from −60° C. to 60° C. in 5° C. increments. The Tan Delta characteristic was used as a measure of the vibration damping capability of the construction. The maximum Tan Delta (peak damping ratio (Tan δ), or peak Tan Delta) measurement results are reported in Table 1. The examples with the barrier layers exhibited a 13% to 293% increase in Tan Delta above comparative 50 C, which was without barrier layers.

TABLE 1
Maximum Tan Delta Measured by DTMA

| | Frequency | | | | | | | |
|---|---|---|---|---|---|---|---|---|
| | 0.1 Hz | | 1 Hz | | 10 Hz | | 100 Hz | |
| | Temperature | Maximum | Temperature | Maximum | Temperature | Maximum | Temperature | Maximum |
| Example | (° C.) | Tan Delta | (° C.) | Tan Delta | (° C.) | Tan Delta | (° C.) | Tan Delta |
| 50C | −45.09 | 0.1401 | −45.10 | 0.1740 | −40.11 | 0.1762 | −30.10 | 0.2056 |
| 51 | −50.10 | 0.1919 | −45.11 | 0.1966 | −40.10 | 0.1991 | −30.12 | 0.2447 |
| 52 | −50.09 | 0.2049 | −45.09 | 0.2151 | −40.11 | 0.2143 | −35.11 | 0.2306 |
| 54 | −50.06 | 0.4205 | −45.09 | 0.4204 | −40.09 | 0.4140 | −30.08 | 0.4309 |
| 55 | −15.10 | 0.5509 | −10.10 | 0.5265 | −0.10 | 0.4819 | 9.84 | 0.4919 |
| 56 | −50.04 | 0.2219 | −45.09 | 0.2221 | −40.08 | 0.2232 | −35.10 | 0.2582 |

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A fiber reinforced resin matrix composite laminate comprising:
a) a first layer of fiber reinforced resin matrix comprising a first resin matrix;
b) a second layer of fiber reinforced resin matrix comprising a second resin matrix; and
c) a viscoelastic construction located between said first and second layers of fiber reinforced resin matrix, bound to said first and second resin matrices, comprising:
i) at least one viscoelastic layer; and
ii) at least one barrier layer;
wherein said viscoelastic and barrier layers may be one and the same layer or may be different layers.

2. The fiber reinforced resin matrix composite laminate according to claim 1 wherein the viscoelastic construction comprises a single layer which is both a viscoelastic layer and a barrier layer.

3. The fiber reinforced resin matrix composite laminate according to claim 1 wherein the viscoelastic construction is a single layer which is both a viscoelastic layer and a barrier layer.

4. The fiber reinforced resin matrix composite laminate according to claim 1 wherein at least one viscoelastic layer differs in composition from at least one barrier layer.

5. The fiber reinforced resin matrix composite laminate according to claim 4 wherein the viscoelastic construction comprises at least two barrier layers which differ in composition from at least one viscoelastic layer and wherein the at least two barrier layers are bound to said first and second resin matrices.

6. The fiber reinforced resin matrix composite laminate according to claim 1 wherein said barrier layer(s) are substantially impermeable to organic solvents.

7. The fiber reinforced resin matrix composite laminate according to claim 1 wherein said barrier layer(s) are substantially impermeable to water, organic solvents and gasses.

8. The fiber reinforced resin matrix composite laminate according to claim 1 wherein at least one of the viscoelastic layers have a peak damping ratio (Tan δ) of at least 1.0 as measured in shear mode by DMTA at 10 Hz.

9. The fiber reinforced resin matrix composite laminate according to claim 1 wherein the viscoelastic construction additionally comprises at least one cured adhesive layer having a composition different from that of the resin matrix.

10. The fiber reinforced resin matrix composite laminate according to claim 1 wherein at least one of the first and second layer of fiber reinforced resin matrix additionally comprises at least one core layer of foam, wood, or honeycomb construction.

11. A method of making a fiber reinforced resin matrix composite laminate comprising the steps of:
a) providing a first curable fiber reinforced resin matrix comprising a first curable resin matrix;
b) providing a second curable fiber reinforced resin matrix comprising a second curable resin matrix;
c) providing a viscoelastic construction, comprising:
i) at least one viscoelastic layer; and
ii) at least one barrier layer;
wherein said viscoelastic and barrier layers may be one and the same layer or may be different layers;
d) providing a tool having a shape which is the inverse of the desired shape of the laminate;
e) laying up the first curable fiber reinforced resin matrix, viscoelastic construction and the second curable fiber reinforced resin matrix in the tool, in that order; and
f) curing the curable resin matrixes to make a fiber reinforced resin matrix composite laminate.

12. The method according to claim 11 wherein the viscoelastic construction comprises a single layer which is both a viscoelastic layer and a barrier layer.

13. The method according to claim 11 wherein the viscoelastic construction is a single layer which is both a viscoelastic layer and a barrier layer.

14. The method according to claim 11 wherein at least one viscoelastic layer differs in composition from at least one barrier layer.

15. The method according to claim 11 wherein the viscoelastic construction comprises at least two barrier layers which differ in composition from at least one viscoelastic layer and wherein the at least two barrier layers are bound to said first and second resin matrices.

16. The method according to claim 11 wherein said barrier layer(s) are substantially impermeable to organic solvents.

17. The method according to claim 11 wherein said barrier layer(s) are substantially impermeable to water, organic solvents and gasses.

18. The method according to claim 11 wherein at least one of the viscoelastic layers have a peak damping ratio (Tan δ) of at least 1.0 as measured in shear mode by DMTA at 10 Hz.

19. The method according to claim 11 wherein the viscoelastic construction additionally comprises at least one cured adhesive layer having a composition different from that of the resin matrix.

20. The method according to claim 11 wherein at least one of the first and second layer of fiber reinforced resin matrix additionally comprises at least one core layer of foam, wood, or honeycomb construction.

21. A viscoelastic construction, comprising:
i) at least one viscoelastic layer; bound to
ii) at least one barrier layer,
where at least one barrier layer differs in composition from at least one viscoelastic layer.

22. The viscoelastic construction according to claim 21 which comprises at least two barrier layers bound to a viscoelastic layer.

23. The method according to claim 21 wherein said barrier layer(s) are substantially impermeable to organic solvents.

24. The method according to claim 21 wherein said barrier layer(s) are substantially impermeable to water, organic solvents and gasses.

25. The method according to claim 21 wherein at least one of the viscoelastic layers have a peak damping ratio (Tan δ) of at least 1.0 as measured in shear mode by DMTA at 10 Hz.

26. The method according to claim 22 wherein said barrier layer(s) are substantially impermeable to organic solvents.

27. The method according to claim 22 wherein said barrier layer(s) are substantially impermeable to water, organic solvents and gasses.

28. The method according to claim 22 wherein at least one of the viscoelastic layers have a peak damping ratio (Tan δ) of at least 1.0 as measured in shear mode by DMTA at 10 Hz.
